(19) United States
(12) Patent Application Publication
(10) Pub. No.: US 2007/0086347 A1
(43) Pub. Date: Apr. 19, 2007

(54) Data packet node, and method of operating a data packet network

(76) Inventor: Paul Laurence Reynolds, Wells (GB)

Correspondence Address: KNOBBE MARTENS OLSON & BEAR LLP, 2040 MAIN STREET, FOURTEENTH FLOOR, IRVINE, CA, 92614, US

(21) Appl. No.: 11/580,491

(22) Filed: Oct. 13, 2006

Related U.S. Application Data
(63) Continuation of application No. PCT/GB05/01386, filed on Apr. 11, 2005.

(30) Foreign Application Priority Data
Apr. 13, 2004 (GB) GB 0408238.4

(51) Int. Cl. H04L 12/26; H04L 12/28

(52) U.S. Cl. 370/237; 370/351

(57) ABSTRACT

A method for transmitting data from a plurality of data sources across data packet communications networks having a congestion control mechanism for reducing the effects of congestion by selectively prioritizing data packets is disclosed. In one embodiment, the data packets can contain data in a number of different multimedia types, e.g., voice, video, audio, e-mail, each being within a separate partition in the packet. The packets can be transmitted as a data packet train, which may consist of a number of data packets with some association in time and order of precedence.

### CROSS-REFERENCE TO RELATED APPLICATIONS

This application is a continuation, under 35 U.S.C. §120, of International patent application No. PCT/GB2005/001386 filed Apr. 11, 2005 under the Patent Cooperation Treaty (PCT), which was published by the International Bureau in English on Oct. 27, 2005, with International Publication Number WO 2005/101755 A1, which designates the United States and claims the benefit of GB Application No. 0408238.4, filed Apr. 13, 2004. All above-referenced prior applications are incorporated by reference herein in their entirety and are hereby made a portion of this specification.

### BACKGROUND OF THE INVENTION

1. Field of the Invention

This invention relates to data packet nodes, and methods of operating a data packet network, incorporating quality control mechanisms for the transmission of data across the network, and in particular for the transmission of data across a network having a congestion control mechanism for reducing the effect of network congestion by selectively prioritising data packets.

2. Description of the Related Technology

A problem with conventional data packet networks is that their operation is based upon a ‘best effort’ paradigm: a data packet is presented to the network without the certainty that it will be delivered. There are no a-priori agreements between the sender and receiver of the data packet to ensure such certainty. However, various techniques have been developed to support quality management of data packet networks, typically including dedicated bandwidth allocation and/or congestion control mechanisms for reducing the effect of network congestion by selectively prioritising data packets. Such congestion control mechanisms include systems where certain data packets can be tagged, to give them priority in their handling over other data packets, or in their tendency not to be discarded, relative to others within the system of lower precedence.

U.S. Pat. No. 5,541,919, describes data source segmentation and multiplexing in a multimedia communications system. Packet segmentation and multiplexing are performed dynamically based on the fullness of a set of information buffers and the delay sensitivity of each data source.

An International workshop submission by Toufik Ahmed et al., of the University of Versailles, entitled “Adaptive MPEG-4 Streaming based on AVO Classification and Network Congestion Feedback” relates to an adaptive object orientated streaming framework for a unicast Moving Picture Expert Group version 4 (MPEG-4) stream over a Transmission Control Protocol—Internet Protocol (TCP-IP) network, with particular application to a Video on Demand (VoD) service. In the MPEG4 standard, video scenes are encoded using object-based compression where different audio visual objects (AVOs) in a scene are encoded separately. The submission employs a streaming server to classify the AVOs using certain application-level QoS criteria and also according to their importance to a scene. The more important AVOs are streamed before the less important ones and the streaming server deals with network congestion by halting the streaming of less important AVOs when congestion is detected.

European patent application EP 0 544 452 describes a system in which core information, for example in the form of a core block or blocks, is transmitted in a core packet, and at least some enahcement information, for example, in the form of enhancement blocks, is transmitted in an enhancement packet which is separate from the core packet and is discardable to relieve congestion. The core and enhancement packets may have headers which include a discard eligible marker to indicate whether or not the associated packet can be discarded. The enhancement blocks may be distributed between the core packet and enhancement packet in accordance with congestion conditions, or the enhancement blocks may be incorporated only in the enhancement packet, and the actual number of enhancement blocks included are varied depending on congestion conditions. The system preserves at least some form of service for a voice signal by dropping enhancement layer data packets from the voice signal during periods of congestion in the network.

A method of operating a data packet network to provide selectable levels of service to different communication flows is disclosed in International patent application WO 02/071702.

Two important works tackling real-time Quality of Service (QoS) in a data packet network are the IntServ and DiffServ approaches, described in R. Braden, et al., “Integrated Services in the Internet Architecture: an Overview,” RFC1633, June 1994 and K. Nichols, et al., “Definition of the Differentiated Services field in the 1Pv4 and 1Pv6 headers,” RFC, December 1998, respectively. The former architecture satisfied both necessary conditions for the network QoS i.e. it provided appropriate bandwidth and queuing resources for each application flow. However, the additional complexity involved in the implementation of the hop signalling renders the process unscalable for public network operation. The latter architecture incorporates queue servicing mechanisms with scheduling and data packet discarding, but does not guarantee bandwidth and thus satisfies only the second necessary condition for QoS.

In United States patent application US 2002/0181506, a scheme for supporting real-time data packetisation of multimedia information is disclosed. The scheme involves storing topics of transmission data packets for a predetermined time period and resending upon detection of lost data packets. The scheme further involves reading a stream into memory prior to processing and therefore cannot be described as true real-time.

A problem common to data packet networks which have congestion control mechanisms which prioritise some data packets over others is that, whilst they enable high priority traffic to be delivered, this is at the expense of low priority traffic. At times of high congestion, this can result in no low priority traffic arriving at the destination.

Another common problem in data packet networks are the delays incurred through the network. Certain data sources have strict time intervals in which their data must arrive at their destination. In order to increase tolerance to delay, it would be desirable to have the facility to prepare resources in advance of data reception.

### SUMMARY OF CERTAIN INVENTIVE ASPECTS

The system, method, and devices of the present invention each have several aspects, no single one of which is solely responsible for its desirable attributes. Without limiting the scope of this invention, several of its features will now be discussed briefly.

In accordance with a first aspect of the present invention, there is provided a method for transmitting data from a plurality of data processing devices across a data packet data communications network having a congestion control mechanism for reducing the effects of congestion by selectively prioritising data packets, the method comprising the steps of:

receiving data from at least a first data processing device and a second data processing device;

constructing a first data packet for carrying data through said network;

constructing a second data packet for carrying data through said network; attaching prioritization information to at least one of the first and second data packets, the prioritization information being for use by the congestion control mechanism to prioritise the first data packet in preference to the second data packet; and

transmitting the first and second data packets into said networks,

characterised in that the first packet construction process comprises adding data from both the first data processing device and the second data processing device to the first data packet in controlled amounts, the amount of data from each of the first and second data processing devices added to the first packet being controlled during the first packet construction process; and

the second packet construction process comprises adding data from at least one of the first and second data processing devices to the second data packet.

Hence, by use of the present invention, even if a second data packet containing data from one or more data processing devices is discarded on its route through the network, it is still possible to deliver an acceptable level of service for two or more data processing devices by delivery of a first data packet containing data from two or more data processing devices. This scheme can clearly be extended to a higher number of data processing devices and data packets, providing further levels of service.

In accordance with a second aspect of the present invention, there is provided a method of transmitting data using a plurality of different data formats across a data packet data communications network, the method comprising the steps of:

selecting a first data format from said plurality of data formats;

adding data to a first data packet, in the first data format;

transmitting the first data packet into the network;

selecting a second, different format from the plurality of data formats;

adding data to a second data packet, in the second data format; and

transmitting the second data packet into the networks

characterised in that before said first data packet is transmitted into the network, advance warning data of the format of said second data packet to be constructed subsequently to said first data packet is added into the first data packet.

By use of the present invention, it is possible to alter the contents of data packets according to present traffic levels and also incorporate advance warning data into the data packets. The advance warning data contains information on data packets to be sent subsequently and can be used by the destination to prepare in advance for the reception of data packets. Such advance warning will inherently enable resources to be more efficiently used and hence reduce delay through the system.

In accordance with a third aspect of the present invention, there is provided a method for transmitting data from a plurality of data processing devices across a data packet data communications network, the method comprising the steps of;

receiving data from at least a first data processing device and a second data processing device;

constructing data packets for carrying data through said network,

characterised in that the packet construction process comprises adding data from both the first data processing device and the second data processing device to the first data packet in controlled amounts, the amount of data from each of the first and second data processing devices added to the first packet being controlled during the first packet construction process; and

the relative proportions of data from the first and second data processing devices in the data packets are varied in dependence on current conditions of transmission of data through the network.

In certain embodiments, this aspect of the invention provides for the dynamic partitioning of packets based on current network conditions.

Further features and advantages of the invention will become apparent from the following description of preferred embodiments of the invention, given by way of example only, which is made with reference to the accompanying drawings.

### BRIEF DESCRIPTION OF THE DRAWINGS

In this description, reference is made to the drawings wherein like parts are designated with like numerals throughout.

FIG. 1 is an overall system diagram of an example data packet switched communication network.

FIG. 2 is a schematic illustration of a data packet train transmitter according to an embodiment of the invention.

FIG. 3 is a schematic illustration of the partitioning of three data packet payloads of a data packet train according to an embodiment of the invention.

### DETAILED DESCRIPTION OF THE CERTAIN INVENTIVE EMBODIMENTS

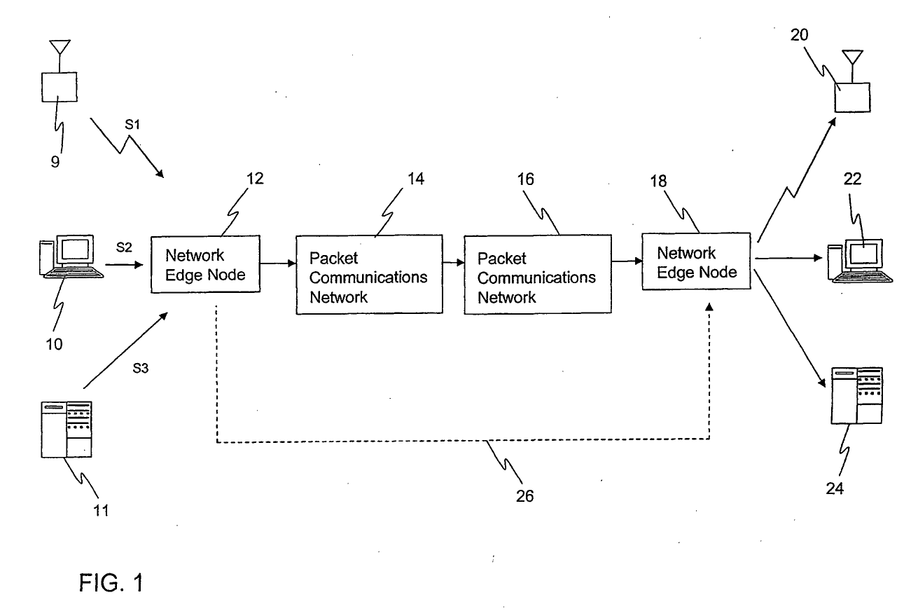

An overall system diagram according to an embodiment of the invention is shown in FIG. 1. This gives an example of a communications system where the present invention could be applied, but is by no means the only scenario of application. A set of data processing devices, 9, 10, 11, are shown on the left hand side of the diagram. These devices could include one or more of a wireless device 9, such as a cellular telephone, personal digital assistant (PDA), laptop computer, etc., a computer workstation 10 and/or a server computer 11. The devices produce different types of data, S1, S2, S3, which are received by a first network edge node 12 e.g. a cellular communications network base station.

The data is passed on through a first data packet communications network 14 such as a mobile communications data packet network, for example a General Data packet Radio Network (GPRS). The data is then communicated via a second data packet communications network 16, for example an internet backbone network, to a second network edge node 18. The data is then passed from the second edge node 18 on to at least one of a variety of data processing devices 20, 22, 24 similar to the wireless device 9, computer workstation 10, or server computer 11 mentioned above.

The present invention provides improved data transmission mechanisms, which may be implemented in the first network edge node 12, whereby information can be transmitted through the data packet network infrastructure elements 14, 16 and received at the second network edge node 18. This is indicated on FIG. 1 by the dotted arrow 26.

The invention provides tine new and interrelated features which may be implemented in the first network edge node to support synchronized multimedia data packet traffic:

1. The transmission of data using mixed multi-media (“MMM”) data packet trains;

2. The transmission of MMM data packets having a priori knowledge of the format of subsequent data packets; and

3. Adaptive MMM data packet partitioning.

MMM Data Packet Trains

An MMM data packet is a data packet that can contain data in a mixture of multimedia types. These multimedia types could be voice, video, audio, email, etc. Some types of multimedia data can have the requirement of real-time operation, in applications such as voice calls, video conferencing and radio. The other types, such as email, are not intended for real-time use and are referred to herein as asynchronous data types. There is then, a need to distinguish between these different data types and handle their routing accordingly.

In an embodiment of the present invention, transcoders are employed to convert data into a format suitable for being sent across a data packet network based upon the congestion characteristic at that point in time. The data is then data packetised into data packet trains, each data packet train including a plurality of data packets and each of the plurality of data packets including data from at least one of the sources. The data packets within a train need not necessarily be sent together, travel through the network together or arrive together.

A data packet train is defined as a set of data packets that have an association in time, and an order of precedence. MMM data packet trains are formed sequentially, such that respective data packet trains are created using source data received, and transmitted, during a respective and sequential periods of time. There must be a minimum of two data packets in a train to form an association between them, but the upper limit is undefined and would be determined by the particular implementation and type of data passing through it. A physical constraint on the size of a data packet train is the total amount of information that can be stored in the buffers.

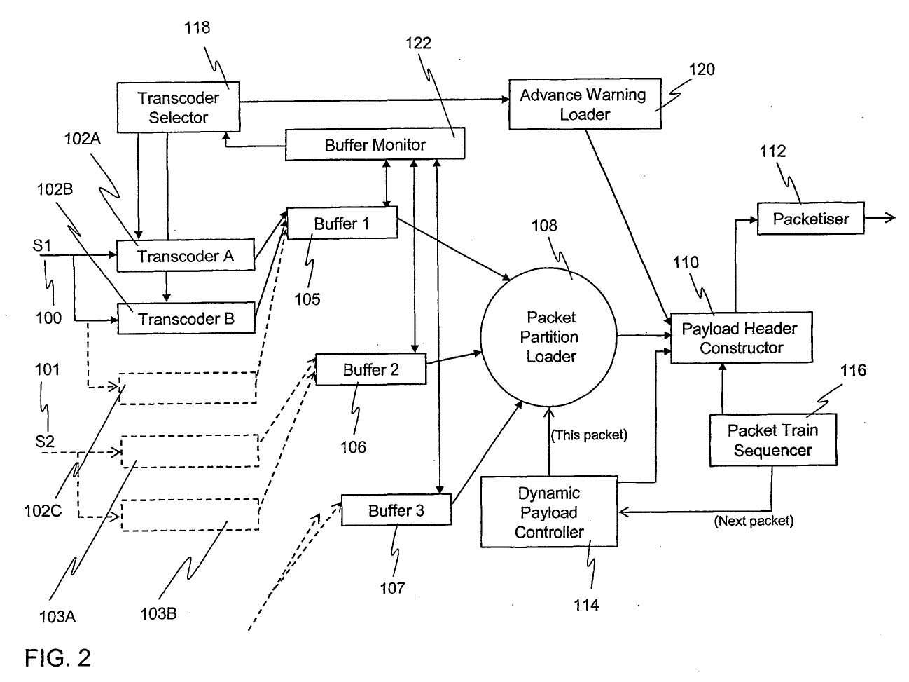

A data packet train transmitter system according to one embodiment of the present invention is shown in FIG. 2. A number of input data sources 100, 101, etc. are fed into a number of transcoders 102A, 102B, 102C; 103A, 103B, etc. In FIG. 2, only two input data sources, S1 and S2, are shown, but it should be appreciated that more are possible in practice. Similarly, only a given number of transcoders are shown, but there also can be many more. The transcoders then feed the data on to a plurality of buffers 105, 106, 107, of which there is at least one for each source S1, S2, etc., which hold the data until requested by the data packet partition loader 108.

The buffer monitor 122 provides information to the transcoder selector 118 in response to detecting a predetermined fill level of the buffers, to indicate which buffers are becoming full. The transcoder selector 118 uses this information to select which of the transcoders 102, 104 to use for the data to be transcoded next. The transcoder selector 118 also feeds information about a change of trans coder affecting a subsequent data packet on to the payload header constructor 110 via an advance warning loader 120 so that this information can be added to the data packet header to reduce system delay in the reverse transcoding process at the second network edge node 18. Once the data packet partition loader 108 has loaded the data packet partitions, the payload header constructor 110 adds a MMM data packet header to each data packet.

Control of the data packet partition loader 108 and the payload header constructor 110 is carried out by a dynamic payload controller 114 which decides on the partition length and contents of each data packet. The number and order of data packets in a train is then calculated by the data packet train sequencer 116 which informs the payload header constructor 110 of its decisions, so that this information can also be added to the MMM data packet headers. Finally, a packetiser 112 is used to create the completed data packets by appending a transport protocol header to form each :MMM data packet, so that they can be transmitted into the existing network infrastructure with suitable routing information indicating the destination of the data, which in this embodiment is the second network edge node 18. At the second network edge node, the data from each of the sources in the MMM data packet train is separately reconstructed and forwarded to the suitable receiving terminal 20, 22 or 24.

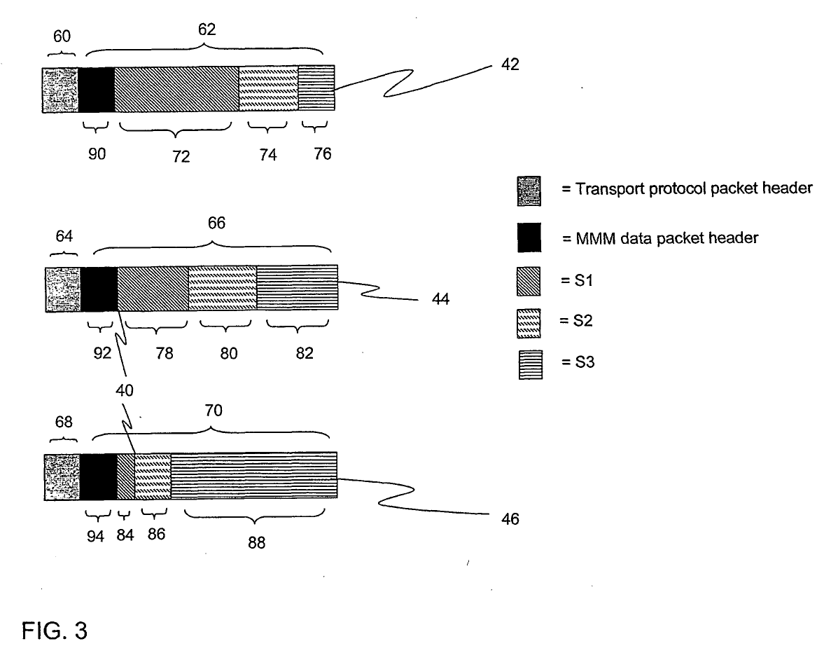

At least one of, and sometimes all of, the data packets in an MMM data packet train are divided into several partitions of different length, as shown in FIG. 3, with boundaries 40 between the partitions containing data from each different data source. In the embodiment shown in FIG. 3, the MMM data packet train includes a first data packet 42, a second data packet 44 and a third data packet 46.

The contents of each partition in each data packet are taken from different respective data sources S2, S2 and S3. The packet partition loader 108 allocates each source an associated level of importance; in the embodiment shown, data source S1 has the highest level of importance, followed by S2, and S3 has the lowest level of importance. The packet partition loader 108 uses this relative importance hierarchy to determine the amounts of data from each source to be included in each different packet in the MMM data packet train. In the first packet 42, the packet partition loader 108 includes a relatively high proportion of data from the first source S1, a lesser proportion of data from the second source S2, and relatively low proportion of data from the third source S3. In the second packet 44, the packet partition loader 108 includes, relative to the amounts included in the first packet 42, a lower proportion of data from the first source S1, a higher proportion of data from the second source S2, and a higher proportion of data from the third source S3. In the third packet 46, the packet partition loader 108 includes, relative to the amounts included in the second packet 44, a lower proportion of data from the first source S1, a higher proportion of data from the second source S2, and a higher proportion of data from the third source S3. Moreover, in the third packet 46, the packet partition loader 108 includes a relatively low proportion of data from the first source S1, a higher proportion of data from the second source S2, and relatively high proportion of data from the third source S3.

Note that regions 72, 78 and 84 together constitute data from S1. Similarly regions 74, 80 and 86 together constitute data from S2 and regions 76, 82 and 88 together constitute data from S3. Note that the amount of data from each source included in a packet train is preferably less than then buffer size of the respective source buffer 105, 106, 107, so that the maximum amount of data from each source in the packet train is constrained by the maximum contents of the respective source buffer 105,106, 107.

The different data types may each be given an importance value in dependence on their tolerance to delay, where a least delay-tolerant data type is given the highest priority and a most delay-tolerant data type is given the lowest priority. If two or more data types have an equal delay tolerance, they may be given the same priority level and be grouped into a single priority group. The importance level may also, or alternatively, be based on other factors, such as the importance value of the content of the data type e.g. one data source may be carrying data that has to be delivered for some form of emergency or data which deemed to have no tolerance to delivery failure, such as financial transaction information.

In a preferred embodiment of the invention, each MMM data packet will also contain a MMM header part in the payload, containing information about what data the data packet contains and how the data packet has been partitioned. This header may be located anywhere within the data packet payload, although as shown in the preferred embodiment of FIG. 3, the payload 48 consists of data from the various sources S1, S2, S3 and the MMM data packet header at its head.

A further header in the form of a transport protocol header 60, 64, 68, is then added at the front of the MMM data packet. This transport protocol header could be the form of known Internet Protocol (IP) or X0.25 protocol headers. Typically, the transport protocol header contains such information as source and destination address, time stamp, length and type of service etc. Note that features of the present invention are intentionally designed such that all the new functionality is contained within existing frameworks i.e. it does not violate the already standardised data packet structures using the known protocols referred to above.

The data packets in the MMM data packet train are arranged in decreasing precedence order. In the example shown in FIG. 3, which contains three MMM data packets, the first data packet 42 is one having a payload 62 of the highest priority. The second data packet 44 is one having a payload 66 of an intermediate priority. The third data packet 46 is one having a payload 70 of the lowest priority.

Precedence values are assigned to each data packet in a descending order, and included in the respective transport protocol header 60, 64, 68, so that the third data packet is discarded during transmission through the packet network infrastructure 16, 18 in preference to the second data packet, and so that the second data packet is discarded during transmission through the packet network infrastructure 16, 18 in preference to the first data packet. Thus, should both the second and third data packets be lost, then the resultant effect upon the most important data is minimized, yet at least some of the least important data also arrives at the destination.

The discarding of data packets may take place at any network node along the path the data takes. If a node is deemed to be congested, then an intelligent process can be used to decide how many data packets must be discarded in order for the congestion to be reduced to an acceptable level. This will take the form of scanning the node buffer, which is currently holding the data to be passed through it. To decide which data packets to discard at a node, the priority levels of the data packets are checked and compared. Starting with the lowest priority first, data packets are discarded until the buffer is sufficiently empty.

Say, for example, there are three data packets in a train, as shown in FIG. 3. The data source S1 has the highest precedence order, data source S2 has an intermediate precedence level, and data source S3 has the lowest precedence level in the train.

The first data packet has a payload that comprises all the mediums that are necessary to make up the multimedia data, as denoted by data from three different data sources, S1, S2 and S3. As S1 is deemed to be the data source with the highest priority or importance value, a large percentage of this data source is allotted to the first data packet in the train, which in turn will have the highest priority of the data packets within the train and hence have the lowest chance of being discarded if there is congestion along the route to the destination.

The payload of the second data packet is partitioned and a lower percentage of data source S1 is added to it. This trend continues in the third data packet, where the remaining data from data source S1 is allocated. The partitioning is slightly different for data source S2; where in this example approximately a quarter of the first data packet is allocated to S2. The allocation in the subsequent data packets decreases accordingly, although not as rapidly as with S1. As data source S3 has the lowest precedence level, the train is partitioned such that the bulk of the capacity of the third data packet is given to S3.

The scenario depicted in FIG. 3 shows the proportion of data source S1 in the first data packet 72 to be larger than that in the second data packet 78, which in turn is larger than that in the third data packet 84 i.e. 72>78>84. The reverse is true for data source S3, with a higher proportion in the third data packet 88 than in the second data packet 82, which in turn is higher than in the first data packet 76 i.e. 76<82<88. This means that if there is little or no congestion from source to destination, and no data packets need be dropped, then all the data from all the sources will be delivered, assuming there are no serious propagation errors throughout the system.

This partitioning pattern, where decreasing amounts of the highest priority data source are allotted to data packets from the front of the train to the back is just one given example and many other patterns can be formed. The partitioning process is repeated throughout the train in a similar vein for a higher number of data sources and hence a higher possible number of partitions in each data packet. Although, not defined precisely, it is envisaged that the number of precedence levels would be between two and ten in the majority of situations.

Information concerning the type of data and partitioning can be contained in each data packet header 90, 92, 94.

The data packet train length is three here, because the association of the three data packets is necessarily of this length as data from each data source spreads over three data packets. The data from these three sources could alternatively be spread over a higher number of data packets than in this example, which would give rise to a longer data packet train containing more data packets.

It should be noted that a data packet does not have to contain data from all the data sources. For example, the third data packet 46 could contain only data from the third source S3, and/or the second data packet 44 could contain data from the second source S2 and data from the third source S3 data but not data from the first source S1.

MMM Data Packets Having a Priori Knowledge

During data transmission it may be necessary, due to network congestion, to reduce the size of the payload and allow for a smaller number of data packets to be transmitted to convey the same information. Thus associated with each store and forward buffer is a set of transcoders 102A, 102B, etc. The selection of which transcoder is to be used will be based upon the degree to which the information rate needs to be reduced. The transcoded information is then inserted into the data packet together with the transcoder code of the transcoder used, so that it can be decoded at the destination edge store and forward buffer.

Within the MMM data packet header, there is provided a small data field that can be used to flag the transcoder to be used for a subsequent data packet. This flag provides a form of advance warning data that can be used to prepare a corresponding reverse transcoding process at the second network edge node 18. In one embodiment, the advance warning flag may be inserted into the MMM data packet immediately preceding the data packet in the train in which the differently transcoded data is included. However, it need not be given in the immediately preceding data packet; it could for example be inserted into a packet in the next data packet train or a data packet which is a predetermined number of packets away in the packet sequence. As long as there is some useful relationship with the current data packet, then an advantage can be obtained by insertion of an advance warning flag.

The advance warning process relies on the intelligence in the end points to intelligently fill data packets and pre-organise resources in the receiving end point for the subsequent data packet. The data field may include information on the transcoder used to convert the original data type or information about a change of transcoder for subsequent data packets. This information can be used to marshal a suitable transcoder to reverse the process at a later stage in the communication process, although the choice of transcoder will also depend on the traffic levels at each. This method of advance warning can be used to reduce delay through the system, which in real-time scenarios would prove very useful.

Adaptive MMM Data Packet Partitioning

The length of the data packet partitions of each type of data in any of the data packets in an MMM data packet train can be varied dynamically according to the type of data present in each buffer and according to current network conditions. Some types of data may be more tolerant to the loss of long data sequences, so larger partitions can be used. If a data type is sensitive to losing even small amounts of data, then small partitions can be created. This ensures that if a data packet is discarded, then only a correspondingly small amount of the sensitive data is lost. In a similar fashion, the partition length may vary according to the tolerance of the data source to delay through the system, whereby data from a delay sensitive data source can be contained in large partitions to reduce processing delay at either end of the network.

Take for example MMM data packets containing voice and video data. The balance between the voice and video content in the composite data packets will be a function of the type of session taking place i.e. whether the session is “vision rich” or “audio rich.” Audio tends to be more towards “bandwidth constant” but if Real-Time Transport Protocol (RTP) is used with silence suppression, then only IP data packets must be sent containing voice when someone is speaking. As a result, the bandwidth becomes more variable, for approximately 20 kbps using G728/9 speech coding algorithms, and no return channel is held. The video is bandwidth variable by definition. This will vary according to the way in which the images are encoded, for example for MPEG and similar formats, it is only necessary to transmit information on changes of the image from frame to frame. Here the refresh rate is the issue, as is the movement of the subject, with more movement requiring further bandwidth resources to cope with the extra change information between subsequent frames. The International Telecommunication Union (ITU) videoconferencing standard H261 using Quarter Common Intermediate Format (QCIF), which has a refresh rate of 30 frames per second, would be adequate for a mobile phone in a video environment.

The size of the IP data packets is also important as data packetisation delay becomes an issue. For audio data, frames of approximately 60 bytes are generated approximately every 20 msec. This creates an interesting engineering problem, which is beyond the scope of this work. For video, again this depends on the refresh rate, which in turn is content dependant.

The above embodiments are to be understood as illustrative examples of the invention. Further embodiments of the invention are envisaged. It is to be understood that any feature described in relation to anyone embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

It will be understood by those of skill in the art that numerous and various modifications can be made without departing from the spirit of the present invention. Therefore, it should be clearly understood that the forms of the invention are illustrative only and are not intended to limit the scope of the invention.

What is claimed is:

1. A method of transmitting data from a plurality of data processing devices across a data packet communications network having a congestion control mechanism for reducing the effects of congestion by selectively prioritising data packets, the method comprising:
receiving data from at least a first data processing device and a second data processing device;
constructing a first data packet for carrying data through the network;
constructing a second data packet for carrying data through the network;
attaching prioritization information to at least one of the first and second data packets, the prioritization information being for use by the congestion control mechanism to prioritise the first data packet in preference to the second data packet; and
transmitting the first and second data packets into the network;
wherein the first packet construction process comprises adding data from both the first data processing device and the second data processing device to the first data packet in controlled amounts, the amount of data from each of the first and second data processing devices added to the first packet being controlled during the first packet construction process; and
the second packet construction process comprises adding data from at least one of the first and second data processing devices to the second data packet.

2. The method of claim 1, wherein the packet construction process is controlled such that the amount of data from the first data processing device in the first data packet is higher than the amount of data from the second data processing device in the first data packet.

3. The method of claim 1, wherein the packet construction process is controlled such that the amount of data from the second data processing device in the first data packet, taken as a proportion of the total amount of data from all data processing device in the first data packet, is lower than the amount of data from the second data processing device in the second data packet, taken as a proportion of the total amount of data from all data processing devices in the second data packet.

4. The method of claim 1, further comprising:
adding data from the first data processing device to the second data packet in a controlled amount, the amount of data from the first data processing device added to the second packet being controlled during the second packet construction process.

5. The method of claim 4, wherein the packet construction process is controlled such that the amount of data from the first data processing device in the second data packet is lower than the amount of data from the second data processing device in the second data packet.

6. The method of claim 4, wherein the packet construction process is controlled such that the amount of data from the first data processing device in the first data packet, taken as a proportion of the total amount of data from all data processing devices in the first data packet, is higher than the amount of data from the first data processing device in the second data packet, taken as a proportion of the total amount of data from all data processing devices in the second data packet.

7. The method of claim 1, further comprising:
receiving data from a third data processing device; and
adding data from the third data processing device to the first data packet in a controlled amount, the amount of data from the third data processing device added to the first packet being controlled during the first packet construction process.

8. The method of claim 7, wherein the first packet construction process is controlled such that the amount of data from the third data processing device in the first data packet is lower than the amount of data from the first data processing device in the first data packet and the amount of data from the second data processing device in the first data packet.

9. The method of claim 1, further comprising:
constructing a third data packet for carrying data through the network, the process of constructing the third packet comprising adding data from at least the first and second data processing devices to the third data packet;
attaching different prioritization information to at least two of the first, second and third data packets, the prioritization information being used by the congestion control mechanism to distinguish between three different levels of prioritization among the three data packets; and
transmitting the third data packet into the network.

10. The method of claim 1, wherein the prioritization information attached to each data packet is based on delay tolerances, whereby a data packet containing more data from a less delay-tolerant data processing device is given a higher priority and a data packet containing more data from a more delay-tolerant data processing device is given a lower priority.

11. The method of claim 1, wherein the prioritization information attached to each data packet is based on the importance value of the content of the data packet, whereby a data packet containing data from a more important data processing device is given a higher priority and a data packet containing data from a less important data processing device is given a lower priority.

12. The method of claim 1, further comprising controlling congestion at a network node in a data packet communications network, wherein the controlling congestion comprises:
receiving at least a first and a second data packet through the network;
prioritising at least one of the first or second data packets in preference to the other, according to prioritization information contained within at least one of the first and second data packets;
reducing congestion at the node by keeping the data packet with the higher priority level and discarding the other.

13. A method of transmitting data using a plurality of different data formats across a data packet data communications network, the method comprising:
selecting a first data format from the plurality of data formats;
adding data to a first data packet, in the first data format;
transmitting the first data packet into the network;
selecting a second, different format from the plurality of data formats;
adding data to a second data packet, in the second data format; and
transmitting the second data packet into the network,
wherein before the first data packet is transmitted into the network, advance warning data of the format of the second data packet to be constructed subsequently to said first data packet is added into the first data packet.

14. The method of claim 13, wherein the first data format is produced by a first transcoder selected from a plurality of transcoders and the second data format is produced by a different transcoder selected from the plurality of transcoders.

15. The method of claim 13, wherein the advance warning data is used to reduce delay by the efficient use of resources, and wherein the reducing delay comprises:
receiving at least a first data packet containing advance warning data;
using the advance warning data to prepare for the reception of a second data packet; and
receiving the second data packet.

16. A method of transmitting data from a plurality of data processing devices across a data packet data communications network, the method comprising:
receiving data from at least a first data processing device and a second data processing device;
constructing data packets for carrying data through said network,
wherein packet construction process comprises adding data from both the first data processing device and the second data processing device to the first data packet in controlled amounts, the amount of data from each of the first and second data processing devices added to the first packet being controlled during the first packet construction process; and
wherein the relative proportions of data from the first and second data processing devices in the data packets are varied in dependence on current conditions of transmission of data through the network.

17. A computer-readable medium having computer-executable instructions stored therein, that when executed perform a method of transmitting data from a plurality of data processing devices across a data packet data communications network, the method comprising:
receiving data from at least a first data processing device and a second data processing device; and
constructing data packets for carrying data through the network,
wherein the packet construction process comprises adding data from both the first data processing device and the second data processing device to the first data packet in controlled amounts, the amount of data from each of the first and second data processing devices added to the first packet being controlled during the first packet construction process;
wherein the relative proportions of data from the first and second data processing devices in the data packets are varied in dependence on current conditions of transmission of data through the network.

18. A system for transmitting data using a plurality of different data formats across a data packet data communications network, the system comprising:
means for selecting a first data format from the plurality of data formats;
means for adding data to a first data packet, in the first data format;
means for transmitting the first data packet into the network;
means for selecting a second, different format from the plurality of data formats;
means for adding data to a second data packet, in the second data format; and
means for transmitting the second data packet into the network,
wherein before the first data packet is transmitted into the network, advance warning data of the format of the second data packet to be constructed subsequently to said first data packet is added into the first data packet.
